(19) United States
(12) Patent Application Publication
(10) Pub. No.: US 2015/0340866 A1
(43) Pub. Date: Nov. 26, 2015

(54) POWER SUPPLY SYSTEM

(71) Applicant: Norbert PLÖTT, Erlangen (DE)

(72) Inventor: Norbert PLÖTT, Erlangen (DE)

(73) Assignee: Siemens Aktiengesellschaft, Munich (DE)

(21) Appl. No.: 14/411,221

(22) PCT Filed: Jun. 26, 2012
(86) PCT No.: PCT/EP2012/062315

§ 371 Date: Dec. 24, 2014

(51) Int. Cl. H02J 3/14; G05B 15/02

(52) U.S. Cl. CPC H02J 3/14; G05B 15/02

(57) ABSTRACT

A power supply system has a plurality of power generating devices and a plurality of power consuming devices. The power generating devices and the power consuming devices are interconnected by a power transmission network. At least one of the power generating devices or at least one of the power consuming devices has a control device which is suitable, in an event of a change of a network frequency of the power transmission network, to at least temporarily vary a power output or power consumption of the power generating device or the power consumption device by a power variation value which is proportional to the temporal change of the network frequency of the power transmission network.

The invention relates to a power supply system comprising a plurality of power generating devices and a plurality of power consuming devices, the power generating devices and the power consuming devices being interconnected by a power transmission network.

In a power supply system for providing electrical energy it is essential to ensure a balance is maintained at all times between fed-in and extracted electrical power. Load fluctuations must be compensated for within seconds of their occurrence so that the system or network frequency of the power supply system or, as the case may be, the power distribution network of the power supply system remains within predefined narrow limits.

To ensure that such a balance can be achieved, power generating devices or generators typically running in synchronism with the system frequency are not utilized up to their full rated capacity, but instead a certain regulating reserve is always held available as a standby.

The object underlying the invention is to disclose a power supply system by means of which fluctuations in network frequency can be more quickly compensated for than in the case of prior art power supply systems.

This object is achieved according to the invention by means of a power supply system having the features recited in claim 1. Advantageous embodiments of the inventive power supply system are disclosed in dependent claims.

According thereto it is inventively provided that at least one of the power generating devices or at least one of the power consuming devices has a control device which is suitable, in the event of a change in the network frequency of the power transmission network, to vary the power output or power consumption of its power generating device or power consuming device at least temporarily by a power variation value which is proportional to the rate of change of the network frequency of the power transmission network.

A significant advantage of the power supply system according to the invention is that network frequency changes of the power transmission network can be compensated for particularly quickly, since in the event of a change in the network frequency a change in the power output or power consumption takes place, said change being proportional according to the invention to the rate of change of the network frequency. Thus, the faster the network frequency changes, the greater also will be the additional power output or power consumption, as a result of which a change in network frequency is advantageously counteracted particularly efficiently and quickly.

An additional power output or power consumption can be realized particularly easily and therefore advantageously through the provision of an energy store; it is accordingly considered advantageous if an energy store is connected to the control device and the control device is embodied in such a way that in the event of an increase in the network frequency of the power transmission network it extracts an amount of energy proportional to the rate of change of the network frequency from the power transmission network and stores said energy in the energy store, and in the event of a decrease in the network frequency of the power transmission network it extracts an amount of energy proportional to the rate of change of the network frequency from the energy store and feeds said energy into the power transmission network.

In order to enable the at least one power generating device or the at least one power consuming device to be connected to the power transmission network in a simple manner, it is considered advantageous if the at least one power generating device or the at least one power consuming device has an inverter comprising at least one intermediate circuit capacitor.

If such an inverter is present, it is considered advantageous if the energy store is formed by means of the at least one intermediate circuit capacitor of the inverter and the control device is embodied in such a way that in the event of an increase in the network frequency of the power transmission network it extracts an amount of energy proportional to the rate of change of the network frequency from the power transmission network and stores said energy in the intermediate circuit capacitor of the inverter, and in the event of a decrease in the network frequency of the power transmission network it extracts an amount of energy proportional to the rate of change of the network frequency from the intermediate circuit capacitor of the inverter and feeds said energy into the power transmission network.

Alternatively it is also possible to buffer energy in a battery; accordingly it is considered advantageous according to another embodiment of the power supply system if the at least one power generating device or the at least one power consuming device includes a battery as an energy store, from which energy is extracted or into which energy is fed in the event of a change in the network frequency of the power transmission network, the extracted or fed-in power being proportional to the rate of change of the network frequency of the power transmission network.

It is furthermore possible to buffer energy both in an intermediate circuit capacitor of an inverter and in a battery; accordingly it is also considered advantageous if the at least one power generating device or the at least one power consuming device has an inverter comprising at least one intermediate circuit capacitor, at least one battery and a control device, the control device being embodied in such a way that in the event of an increase in the network frequency of the power transmission network it extracts an amount of energy proportional to the rate of change of the network frequency from the power transmission network and stores said energy in the intermediate circuit capacitor and the battery, and in the event of a decrease in the network frequency of the power transmission network it extracts an amount of energy proportional to the rate of change of the network frequency from the intermediate circuit capacitor and the battery and feeds said energy into the power transmission network.

Preferably the at least one power generating device is a solar power generating device or a wind power generating device.

The invention furthermore relates to a power generating device for a power supply system having a power transmission network as described hereinabove. According to the invention it is provided in respect of such a power generating device that a control device of the power generating device is embodied in such a way that in the event of a change in the network frequency of the power transmission network the power output of the power generating device varies at least temporarily by a power variation value which is proportional to the rate of change of the network frequency of the power transmission network.

With regard to the advantages of the power generating device according to the invention let reference be made to the statements made above in connection with the power supply system according to the invention, since the advantages of the power supply system according to the invention correspond to those of the generating device according to the invention.

With regard to the embodiment of the power generating device it is considered advantageous if the control device is embodied in such a way that in the event of an increase in the network frequency of the power transmission network it extracts an amount of energy proportional to the rate of change of the network frequency from the power transmission network and stores said energy in an energy store of the power generating device, and in the event of a decrease in the network frequency of the power transmission network it extracts an amount of energy proportional to the rate of change of the network frequency from the energy store and feeds said energy into the power transmission network.

The invention furthermore relates to a power consuming device for a power supply system having a power transmission network as has been described hereinabove. According to the invention it is provided in respect of such a power consuming device that a control device of the power consuming device is embodied in such a way that in the event of a change in the network frequency of the power transmission network it varies the power consumption of the power consuming device at least temporarily by a power variation value which is proportional to the rate of change of the network frequency of the power transmission network.

With regard to the advantages of the power consuming device according to the invention let reference be made to the statements made above in connection with the power supply system according to the invention, since the advantages of the power supply system according to the invention correspond to those of the power consuming device according to the invention.

With regard to the power consuming device it is considered particularly advantageous if the control device is embodied in such a way that in the event of an increase in the network frequency of the power transmission network it extracts an amount of energy proportional to the rate of change of the network frequency from the power transmission network and stores said energy in an energy store of the power consuming device, and in the event of a decrease in the network frequency of the power transmission network it extracts an amount of energy proportional to the rate of change of the network frequency from the energy store and feeds said energy into the power transmission network.

The invention furthermore relates to a method for operating a power supply system comprising a plurality of power generating devices and a plurality of power consuming devices, the power generating devices and the power consuming devices being interconnected by a power transmission network.

According to the invention it is provided in respect of such a method that in the event of a change in the network frequency of the power transmission network the power output or power consumption of at least one of the power generating devices or at least one of the power consuming devices will be varied at least temporarily in proportion to the rate of change of the network frequency of the power transmission network.

With regard to the advantages of the method according to the invention let reference be made to the statements made above in connection with the power supply system according to the invention, since the advantages of the power supply system according to the invention correspond to those of the method according to the invention.

Preferably the change in the power output or power consumption is effected through buffering of energy in an energy store.

It is considered particularly advantageous if the change in the power output or power consumption is effected through buffering of energy at least also in an intermediate circuit capacitor of an inverter.

The invention is explained in more detail below with reference to exemplary embodiments taken in conjunction with the drawings, in which, by way of example:

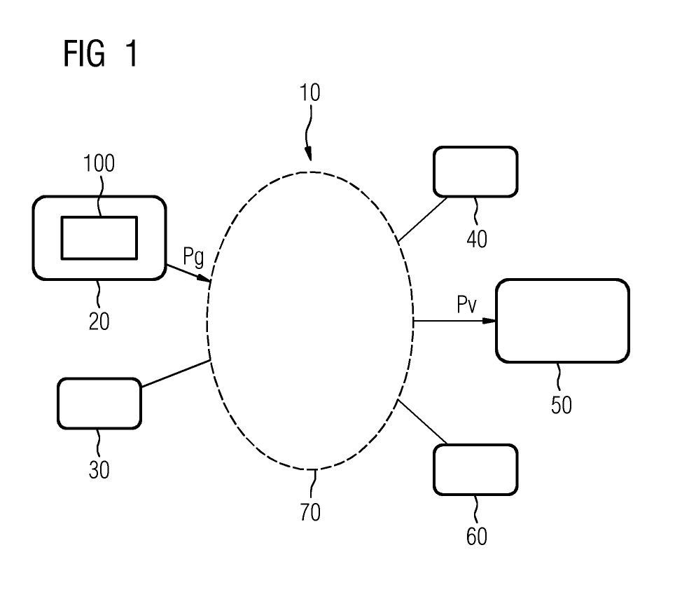

FIG. 1 shows an exemplary embodiment of a power supply system according to the invention which is equipped with an exemplary embodiment of a power generating device according to the invention as well as with an exemplary embodiment of a power consuming device according to the invention,

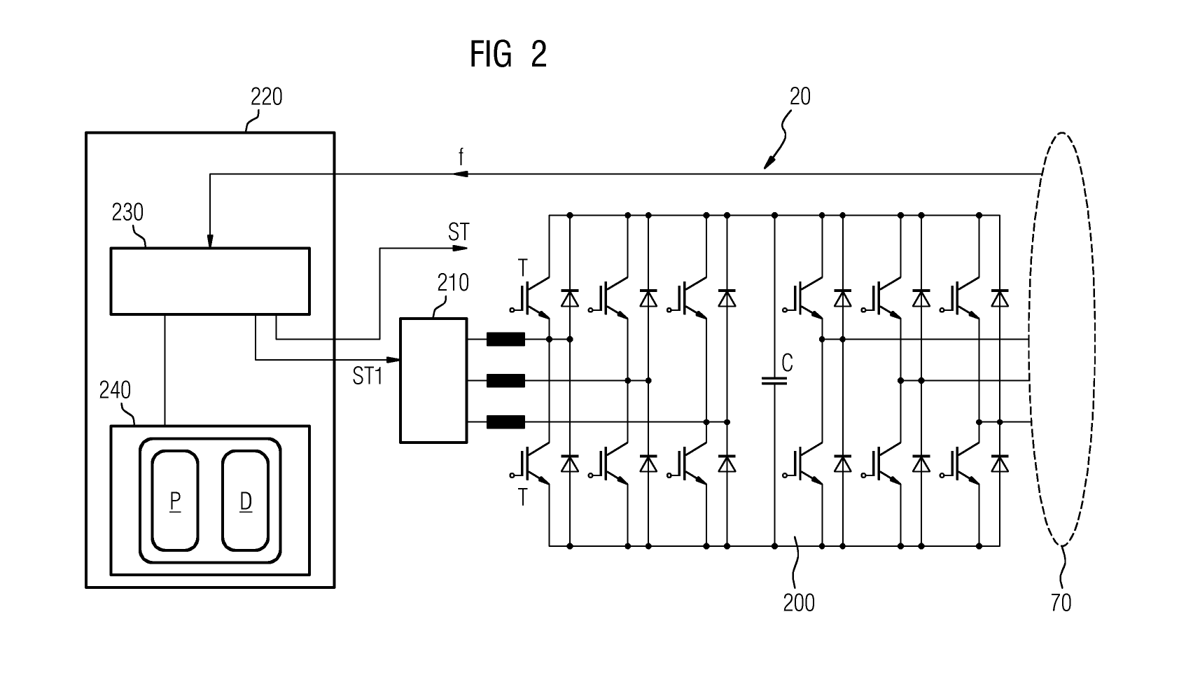

FIG. 2 shows a first exemplary embodiment of a power generating device according to the invention, such as can be used in the power supply system according to FIG. 1,

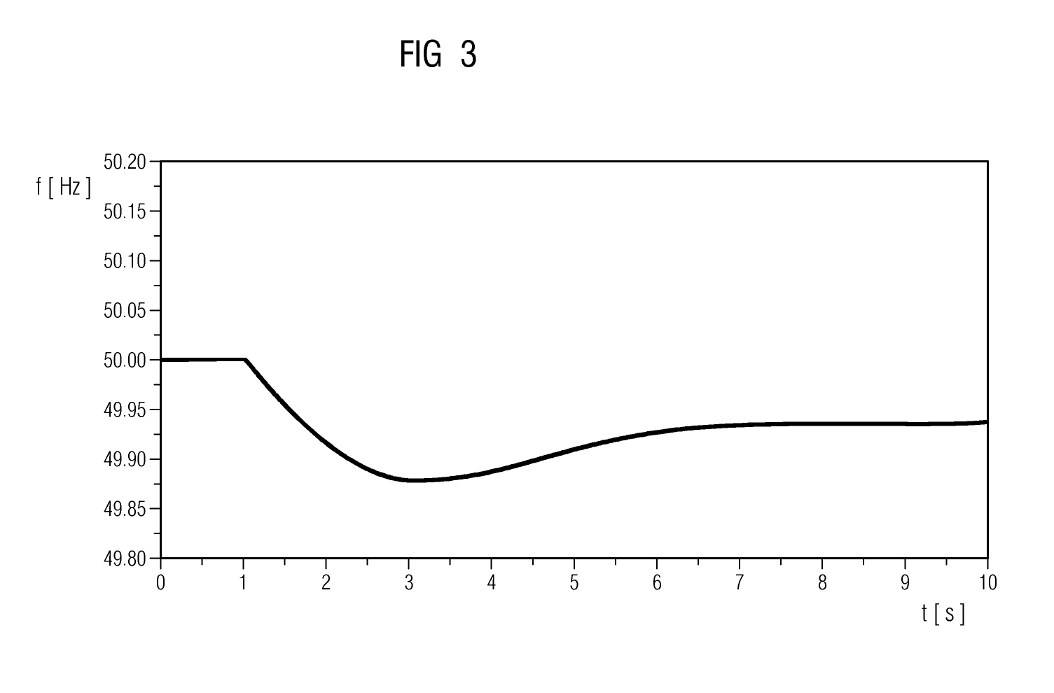

FIG. 3 shows the mode of operation of the power generating device according to FIG. 2 in the case of P control exclusively,

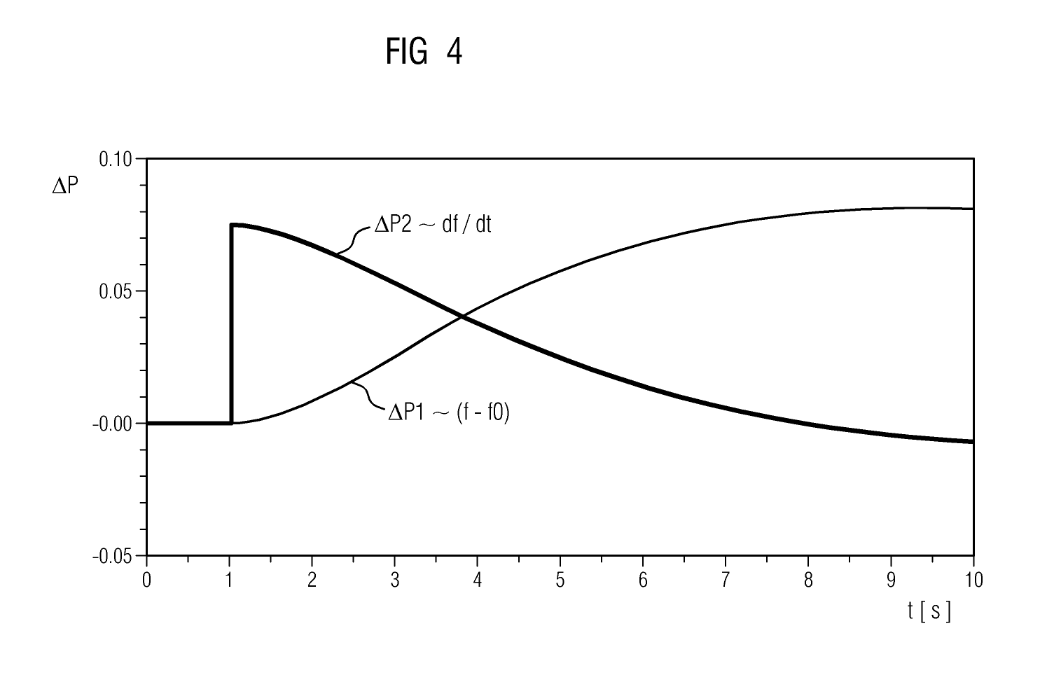

FIG. 4 shows the interaction between P control and D control in the case of the power generating device according to FIG. 2 in greater detail,

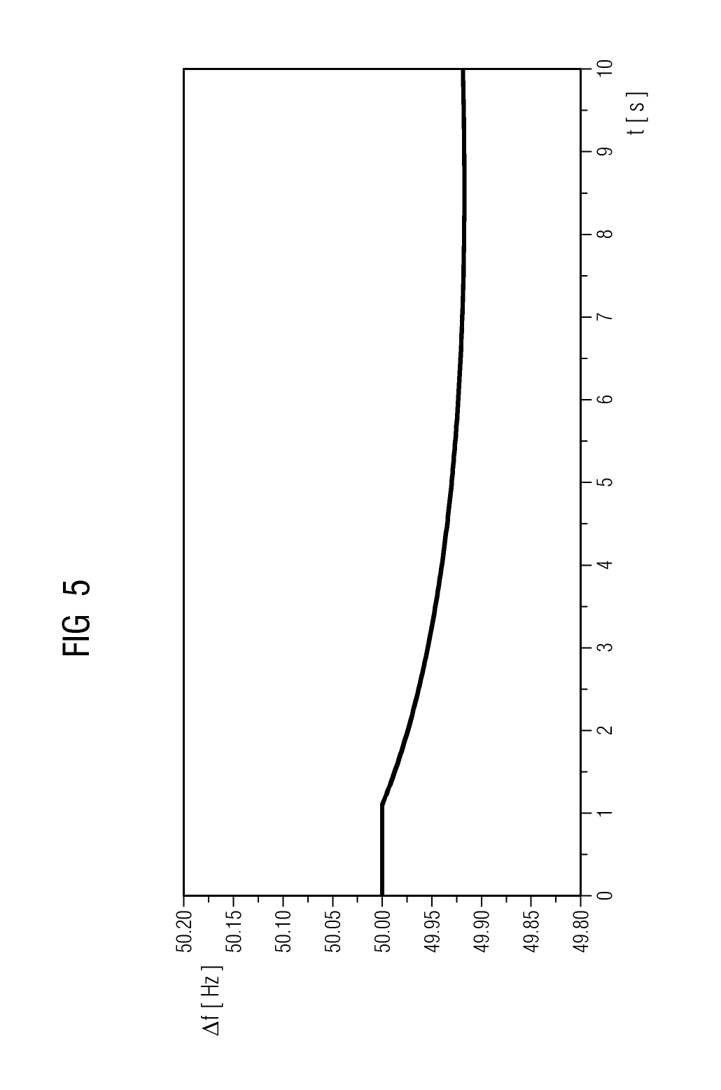

FIG. 5 shows the overlaying of D control and P control in the case of the power generating device according to FIG. 2,

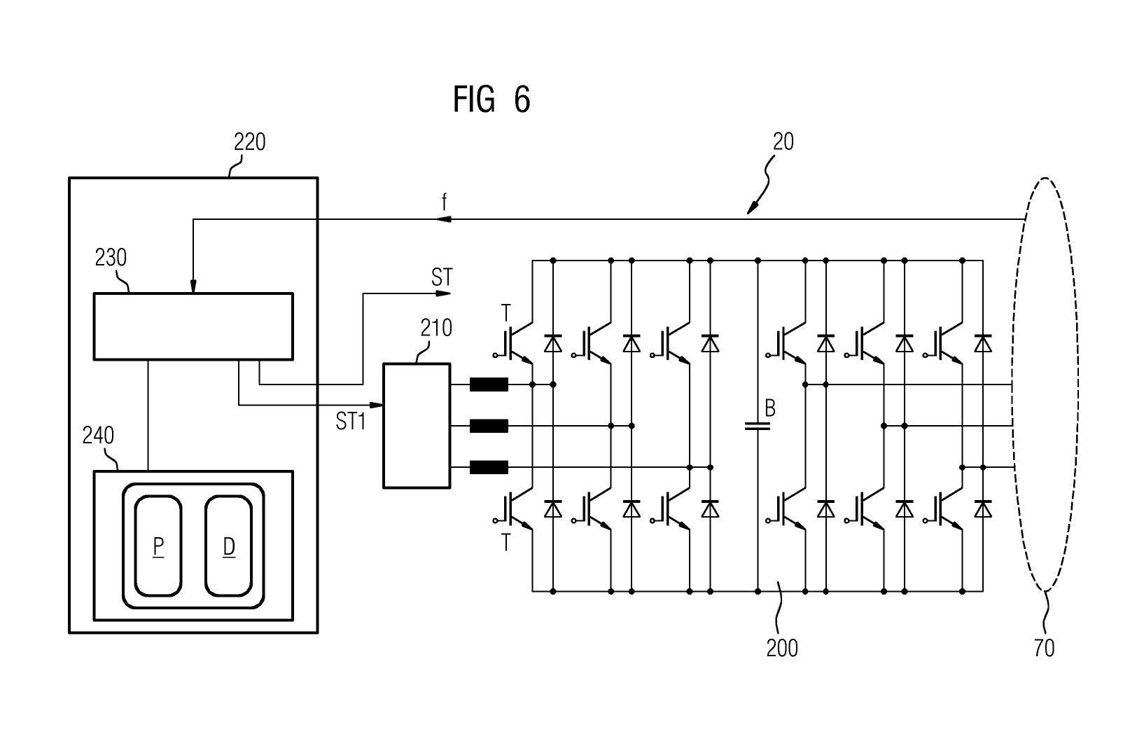

FIG. 6 shows an exemplary embodiment of a power generating device according to the invention which is equipped with a battery,

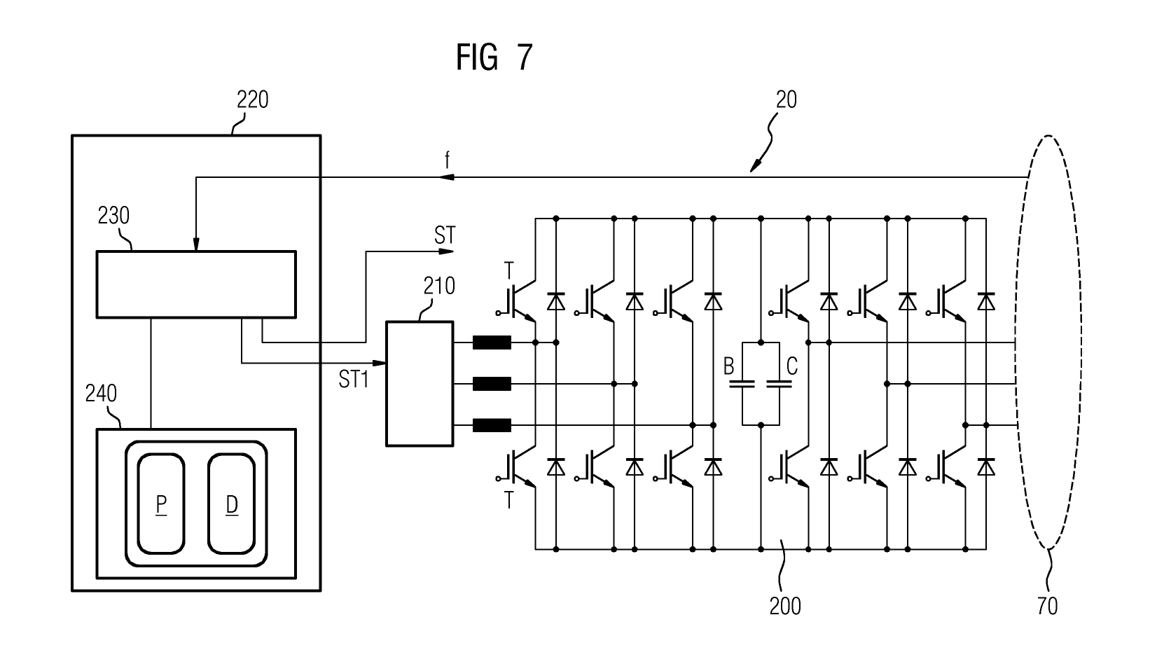

FIG. 7 shows an exemplary embodiment of a power generating device according to the invention which is equipped with an intermediate circuit capacitor and a battery,

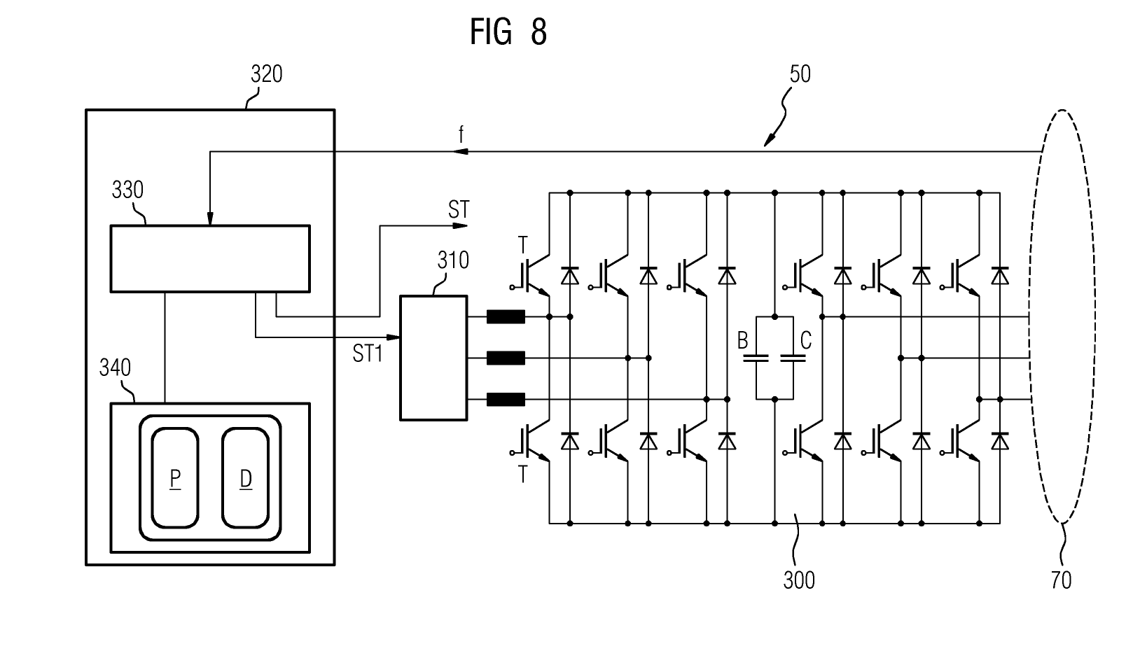

FIG. 8 shows an exemplary embodiment of a power consuming device according to the invention, such as can be used in the power supply system according to FIG. 1, and

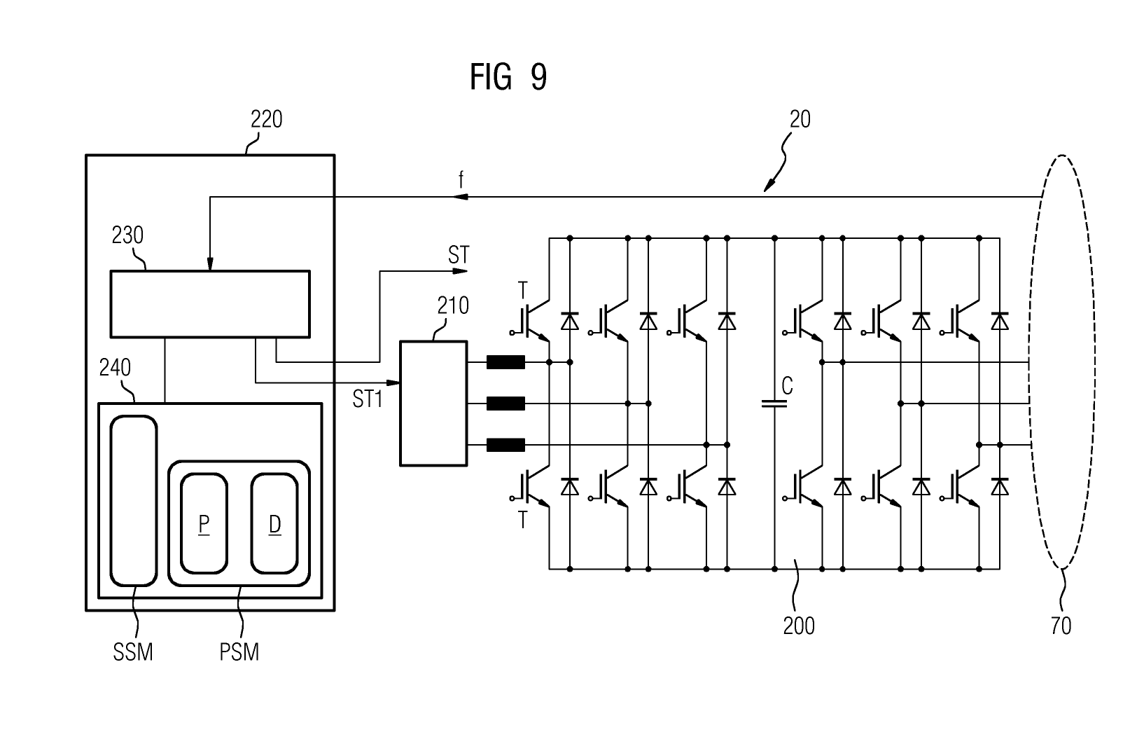

FIG. 9 shows an exemplary embodiment of a power generating device according to the invention having primary and secondary control.

For clarity of illustration reasons the same reference signs are used consistently throughout the figures for identical or comparable components.

FIG. 1 shows a power supply system 10 which is equipped with two power generating devices 20 and 30 as well as three power consuming devices 40, 50 and 60. The electrical connection between the power generating devices 20 and 30 and the power consuming devices 40, 50 and 60 is implemented by way of a power transmission network 70 of the power supply system 10.

In the exemplary embodiment according to FIG. 1, the power generating device 20 is equipped with a control device 100 which, in the event of a change in the network frequency of the power transmission network 70, varies the power Pg of the power generating device 20—at least also—in proportion to the rate of change of the network frequency of the power transmission network. As will be explained in more detail further below, in addition to a change in power which is proportional to the rate of change of the network frequency (D control), a change in power which is proportional to the network frequency deviation is also performed (P control).

In the exemplary embodiment according to FIG. 1, the power consuming device 50 also operates as a function of the rate of change of the network frequency of the power transmission network 70. As will be explained in more detail further below, this is because the power consuming device 50 has the capability to vary the power consumption Pv by temporarily buffering energy at least also in proportion to the rate of change of the network frequency of the power transmission network 70.

FIG. 2 shows an exemplary embodiment of the power generating device 20 according to FIG. 1. It can be seen that the power generating device 20 has an inverter 200 which is connected to the power transmission network 70. The inverter 200 is additionally connected to a controllable generator 210 which is actuated by a control device 220. The control device 220 has a computing device 230 which is connected to a memory 240 of the control device 220. Two program modules D and P, inter alia, are stored in the memory 240.

The program module D serves to enable the computing device 230 to effect a D control function. Within the scope of the D control, the control device 220 generates control signals ST on the output side by means of which transistors T of the inverter 200 are driven in such a way that in the event of a rate of change in the network frequency f of the power transmission network 70 energy is stored in the intermediate circuit capacitor C of the inverter 200 or energy is extracted from said intermediate circuit capacitor C.

In reality the program module D is embodied in such a way that within the scope of the D control, energy generated by the controllable generator 210 is buffered in the intermediate circuit capacitor C when there is an increase in the network frequency f of the power transmission network 70. The power Ps1, by means of which energy is stored in the intermediate circuit capacitor C of the inverter 200, is in this case proportional to the rate of change df/dt of the network frequency f. It therefore holds that:

Ps1=C1*df/dt,

where C1 designates a predefined proportionality factor.

The D control of the control device 220 operates in an analogous manner in the event of a reduction in the network frequency f. In this case the D control will drive the transistors T of the inverter 200 via the control signals ST in such a way that energy is extracted from the intermediate circuit capacitor C and fed into the power transmission network 70 in addition. The power Ps2, which is fed into the power transmission network 70 in addition with the aid of the intermediate circuit capacitor C, is in this case proportional to the rate of change df/dt of the network frequency f. It therefore holds that:

Ps2=C2*df/dt,

where C2 designates a predefined proportionality factor.

The proportionality factors C1 and C2 are preferably identical.

To sum up, on account of the program module D the control device 220 is therefore able to implement a D-type control of the power generating device 20, wherein additional power is fed in if there is a decrease in the network frequency f and the power fed in is reduced if there is an increase in the network frequency f.

The additional program module P in the memory 240 effects a P-type control of the control device 220 which takes place in parallel with the D control. Within the scope of the P control, a control signal is generated on the output side ST1 for the purpose of controlling the controllable generator 210. Within the scope of the P control, the output power of the controllable generator 210 is regulated to a predefined rated power, the power of the controllable generator 210 being increased or decreased in the event of a deviation of the network frequency f from a rated network frequency f0, the increase or decrease being proportional to the deviation of the network frequency f from the rated network frequency f0. The regulation function is therefore a linear type of control which is dependent on the difference between the actual network frequency f and the rated network frequency f0.

FIG. 3 shows the mode of operation of the power generating device 20 according to FIG. 2 when only the program module P of the control device 220 is active and consequently only a P-type control is performed by the computing device 230. It can be seen that in the event of a change in the network frequency f at a time instant t=1 s the P control takes effect only in a very delayed manner and effectively counteracts the drop in the network frequency f only as of a time instant t=3 s, so that the network frequency f only starts to increase again as of that instant owing to an increased amount of energy being fed in.

FIG. 4 shows the mode of operation of the P control of the program module P and the D control of the program module D in the event of a drop in frequency in greater detail.

It can be seen that as of time instant t=1 s the power output of the controllable generator 210 is slowly increased by a value ΔP1 with the aid of the control signal ST1; this increase ΔP1 is proportional to the deviation Δf between the actual network frequency f and the rated network frequency f0. It holds that:

ΔP1˜(f−f0)

Also evident in FIG. 4 is the effect of the D control which is brought about by the program module D. It can be seen that the D control produces a massive impact already at the time instant t=1 s, since it operates in proportion to the rate of change df/dt of the network frequency f. The additional power ΔP2 provided by the D control is extracted from the intermediate circuit capacitor C of the inverter 200, where it holds that:

ΔP2˜df/dt

It can therefore be stated that in the event of a drop in frequency both the D control and the P control bring about an additional power output of the power generating device 20 into the power transmission network 70, the P control being based on control of the controllable generator 210 and the D control on an extraction of energy from the intermediate circuit capacitor C. The power increase effected by the P control is proportional to the frequency deviation, and the additional power output by the D control is proportional to the rate of change of the network frequency f.

In FIG. 5 it is illustrated how the D control and the P control overlay one another. It can be seen that in a cooperative interaction of the two control types the undershooting of the network frequency f shown in FIG. 3 is avoided and all that takes place is a lowering of the network frequency f without undershoot behavior.

FIG. 6 shows a second exemplary embodiment of a power generating device 20 such as may be used in the power supply system 10 according to FIG. 1. It can be seen that instead of an intermediate circuit capacitor C in the inverter 200 a battery B is provided which causes energy to be buffered in the DC voltage circuit of the inverter 200. In all other respects the exemplary embodiment according to FIG. 6 corresponds to the exemplary embodiment according to FIG. 2.

FIG. 7 shows a third exemplary embodiment of a power generating device 20 such as may be used in the power supply system 10 according to FIG. 1. In this exemplary embodiment a battery B is connected into the circuit in parallel with an intermediate circuit capacitor C of an inverter 200, such that a storage of energy proportional to the rate of change of the network frequency of the power transmission network 70 is possible both in the intermediate circuit capacitor C and in the battery B. In all other respects the exemplary embodiment according to FIG. 7 corresponds to the exemplary embodiment according to FIG. 2.

FIG. 8 shows an exemplary embodiment of the power consuming device 50 according to FIG. 1. It can be seen that the power consuming device 50 has an inverter 300 which is connected to the power transmission network 70. In addition the inverter 300 is connected to a controllable power-consuming load 310 which is actuated by a control device 320. The control device 320 has a computing device 330 which is connected to a memory 340 of the control device 320. Two program modules D and P, inter alia, are stored in the memory 340.

The program module D serves to effect a D-type control by means of the computing device 330. Within the scope of the D control, the control device 320 generates control signals ST on the output side by means of which transistors T of the inverter 300 are driven in such a way that energy is stored in the intermediate circuit capacitor C of the inverter 300 or energy is extracted from said intermediate circuit capacitor C as a function of the rate of change of the network frequency f of the power transmission network 70.

In reality the program module D is embodied in such a way that within the scope of the D control, energy coming from the power transmission network 70 is buffered in the intermediate circuit capacitor C when there is an increase in the network frequency f of the power transmission network 70. The power Ps1, by means of which energy is stored in the intermediate circuit capacitor C of the inverter 300, is in this case proportional to the rate of change df/dt of the network frequency f. It therefore holds that:

Ps1=C1*df/dt,

where C1 designates a predefined proportionality factor.

The D control of the control device 320 operates in an analogous manner in the event of a reduction in the network frequency f. In this case the D control will drive the transistors T of the inverter 300 via the control signals ST in such a way that energy is extracted from the intermediate circuit capacitor C and fed into the power transmission network 70. The power Ps2, which is fed into the power transmission network 70 with the aid of the intermediate circuit capacitor C, is in this case proportional to the rate of change df/dt of the network frequency f. It therefore holds that:

Ps2=C2*df/dt,

where C2 designates a predefined proportionality factor.

The proportionality factors C1 and C2 are preferably identical.

To sum up, on account of the program module D the control device 320 is therefore able to implement a D control function, wherein additional power is fed in if there is a decrease in the network frequency f and energy is extracted if there is an increase in the network frequency f.

The additional program module P in the memory 340 effects a P-type control of the control device 320 which takes place in parallel with the D control. Within the scope of the P control, a control signal ST1 is generated on the output side for the purpose of controlling the controllable power-consuming load 310. Within the scope of the P control, the consumption is regulated to a predefined rated consumption, the consumption being increased or decreased in the event of a deviation of the network frequency f from a rated network frequency f0, the increase or decrease being proportional to the deviation of the network frequency f from the rated network frequency f0. The regulation function is therefore a linear type of control which is dependent on the difference between the actual network frequency f and the rated network frequency f0.

The described storage of energy in and extraction of energy from the intermediate circuit capacitor C can additionally or alternatively be realized using a battery B.

FIG. 9 shows a third exemplary embodiment of a power generating device 20 according to the invention such as may be used in the power supply system 10 according to FIG. 1. In this exemplary embodiment the control device 220 has a primary control and a secondary control.

In order to enable the primary control, a primary control software module PSM is stored in the memory 240 of the control device 220. The primary control software module PSM comprises the program module D and the program module P, which have already been described in connection with FIG. 2. When executed by the computing device 230, the primary control software module PSM accordingly effects the D control and the P control, which have already been explained hereinabove in connection with FIG. 2.

In the exemplary embodiment according to FIG. 9, the secondary control is effected by means of a secondary control software module SSM which, when executed by the computing device 230, performs the secondary control of the control device 220. A deviation of the actual frequency f of the transmission network 70 from the rated network frequency f0 which cannot be corrected by the primary control is resolved within the scope of the secondary control. Secondary controls of this type are well-known in the prior art, so no explanations are necessary in this regard.

Although the invention has been illustrated and described in greater detail on the basis of preferred exemplary embodiments, the invention is not limited by the disclosed examples and other variations may be derived herefrom by the person skilled in the art without leaving the scope of protection of the invention.

### LIST OF REFERENCE SIGNS

10 Power supply system

20 Power generating device

30 Power generating device

40 Power consuming device

50 Power consuming device

60 Power consuming device

70 Power transmission network

100 Control device

200 Inverter

210 Generator

220 Control device

230 Computing device

240 Memory

300 Inverter

310 Power-consuming load

320 Control device

330 Computing device

340 Memory

B Battery

C Intermediate circuit capacitor

D Program module

f Network frequency

f0 Rated network frequency

P Program module

Pg Power

Pv Power consumption

PSM Primary control software module

SSM Secondary control software module

ST Control signal

ST1 Control signal

T Transistor

1-14. (canceled)

15. A power supply system, comprising:
a plurality of power generating devices;
a plurality of power consuming devices;
a power transmission network interconnecting said power generating devices with said power consuming devices; and
at least one of said power generating devices or at least one of said power consuming devices having a control device being suitable, in an event of a change in a network frequency of said power transmission network, to vary a power output or power consumption of said at least one power generating device or said at least one power consuming device at least temporarily by a power variation value being proportional to a rate of change of the network frequency of said power transmission network.

16. The power supply system according to claim 15, further comprising an energy store connected to said control device, said control device embodied such that in an event of an increase in the network frequency of said power transmission network said control device extracts an amount of energy proportional to the rate of change of the network frequency from said power transmission network and stores the energy in said energy store, and in an event of a decrease in the network frequency of said power transmission network said control device extracts an amount of energy proportional to the rate of change of the network frequency from said energy store and feeds the energy into said power transmission network.

17. The power supply system according to claim 16, wherein said at least one power generating device or said at least one power consuming device has an inverter having at least one intermediate circuit capacitor.

18. The power supply system according to claim 17, wherein:
said energy store is formed by means of said at least one intermediate circuit capacitor of said inverter; and
said control device is embodied such that in an event of an increase in the network frequency of said power transmission network said control device extracts an amount of energy proportional to the rate of change of the network frequency from said power transmission network and stores the energy in said intermediate circuit capacitor of said inverter, and in an event of a decrease in the network frequency of said power transmission network said control device extracts an amount of energy proportional to the rate of change of the network frequency from said intermediate circuit capacitor of said inverter and feeds the energy into said power transmission network.

19. The power supply system according to claim 15, wherein said at least one power generating device or said at least one power consuming device has a battery as an energy store, from which the energy is extracted or into which the energy is fed in an event of a change in the network frequency of said power transmission network, the extracted or fed-in power being proportional to the rate of change of the network frequency of said power transmission network.

20. The power supply system according to claim 15, wherein said at least one power generating device or said at least one power consuming device has an inverter containing at least one intermediate circuit capacitor, at least one battery and said control device, said control device is embodied such that in an event of an increase in the network frequency of said power transmission network said control device extracts an amount of energy proportional to the rate of change of the network frequency from said power transmission network and stores the energy in said intermediate circuit capacitor and said battery, and in an event of a decrease in the network frequency of said power transmission network said control device extracts an amount of energy proportional to the rate of change of the network frequency from said intermediate circuit capacitor and said battery and feeds the energy into said power transmission network.

21. The power supply system according to claim 15, wherein said at least one power generating device is a solar power generating device or a wind power generating device.

22. A power generating device for a power supply system having a power transmission network, the power generating device comprising:
a control device embodied such that in an event of a change in a network frequency of the power transmission network said control device varies a power output of the power generating device at least temporarily by a power variation value being proportional to a rate of change of a network frequency of the power transmission network.

23. The power generating device according to claim 22, further comprising an energy store, said control device embodied such that in an event of an increase in the network frequency of the power transmission network said control device extracts an amount of energy proportional to the rate of change of the network frequency from the power transmission network and stores the energy in said energy store, and in an event of a decrease in the network frequency of the power transmission network said control device extracts an amount of energy proportional to the rate of change of the network frequency from said energy store and feeds the energy into the power transmission network.

24. A power consuming device for a power supply system having a power transmission network, the power consuming device comprising:
a control device embodied such that in an event of a change in a network frequency of the power transmission network said control device varies a power consumption of the power consuming device at least temporarily by a power variation value being proportional to a rate of change of the network frequency of the power transmission network.

25. The power consuming device according to claim 24, further comprising an energy store, said control device embodied such that in an event of an increase in the network frequency of the power transmission network said control device extracts an amount of energy proportional to the rate of change of the network frequency from the power transmission network and stores the energy in said energy store of the power consuming device, and in an event of a decrease in the network frequency of the power transmission network said control device extracts an amount of energy proportional to the rate of change of the network frequency from said energy store and feeds the energy into the power transmission network.

26. A method for operating a power supply system having a plurality of power generating devices and a plurality of power consuming devices, the power generating devices and the power consuming devices are interconnected by a power transmission network, which comprises the step of:
varying a power output or power consumption of at least one of the power generating devices or at least one of the power consuming devices at least temporarily in proportion to a rate of change of a network frequency of the power transmission network in an event of a change in the network frequency of the power transmission network.

27. The method according to claim 26, which further comprises effecting a change in the power output or the power consumption through buffering of energy in an energy store.

28. The method according to claim 27, which further comprises effecting the change in the power output or the power consumption through buffering of the energy at least also in an intermediate circuit capacitor of an inverter.
